(19) United States
(12) Patent Application Publication
(10) Pub. No.: US 2017/0032000 A1
(43) Pub. Date: Feb. 2, 2017

(54) DATABASE MANAGER

(71) Applicant: Bank of America Corporation, Charlotte, NC (US)

(72) Inventors: Anant Bondalapati Sharma, Telangana (IN); Vamseedhar Chandu, Telangana (IN); Badelal Rameshwar Prasad Yadav, Maharashtra (IN)

(21) Appl. No.: 14/810,558

(22) Filed: Jul. 28, 2015

(51) Int. Cl. G06F 17/30; G06F 12/02

(52) U.S. Cl. CPC G06F 17/30557; G06F 12/023; G06F 2212/251

(57) ABSTRACT

An apparatus stores a schedule indicating when a job is scheduled to execute. The apparatus receives a request to execute a first job and determines from the schedule that a second job is scheduled to execute during the execution of the first job. The apparatus estimates a first amount of memory to be consumed by the first job and a second amount of memory to be consumed by the second job, and determines whether a sum of the first amount and the second amount exceeds an amount of free memory. The apparatus determines a table that the first job accesses, and determines whether the table is accessed by the second job. The apparatus communicates a message indicating a period of time to wait before executing the first job if the sum exceeds the amount of free memory or if the table is accessed during by the second job.

### TECHNICAL FIELD

This disclosure relates generally to a tool for enhancing database job management.

### BACKGROUND

Databases may handle multiple jobs from multiple users concurrently. However, handling several jobs concurrently may result in inefficient execution due to insufficient system resources.

### SUMMARY OF THE DISCLOSURE

According to one embodiment, an apparatus includes a memory and a processor. The memory stores a schedule indicating, for each job of a plurality of jobs, a time when the job is scheduled to execute against a database. The processor receives a request to execute a first job against the database and determines, based on the schedule, that a second job of the plurality of jobs is scheduled to execute during the execution of the first job. The processor estimates a first amount of memory to be consumed by executing the first job and a second amount of memory to be consumed by executing the second job and determines whether a sum of the first amount and the second amount exceeds an amount of free memory. The processor also determines a table of the database that the first job accesses during execution and determines whether the table is accessed during execution of the second job. The processor communicates a message indicating a period of time to wait before executing the first job if the sum of the first amount and the second amount exceeds the amount of free memory or if the table is accessed during execution of the second job.

According to another embodiment, a method may begin by storing a schedule indicating, for each job of a plurality of jobs, a time when the job is scheduled to execute against a database. The method continues by receiving a request to execute a first job against the database and by determining, based on the schedule, that a second job of the plurality of jobs is scheduled to execute during the execution of the first job. The method continues by estimating a first amount of memory to be consumed by executing the first job and a second amount of memory to be consumed by executing the second job and by determining whether a sum of the first amount and the second amount exceeds an amount of free memory. The method continues by determining a table of the database that the first job accesses during execution and by determining whether the table is accessed during execution of the second job. The method concludes by communicating a message indicating a period of time to wait before executing the first job if the sum of the first amount and the second amount exceeds the amount of free memory or if the table is accessed during execution of the second job

According to yet another embodiment, a system may comprise a device and a controller. The device communicates a request to execute a first job against the database. The controller stores a schedule indicating, for each job of a plurality of jobs, a time when the job is scheduled to execute against a database. The controller receives the request to execute the first job against the database and determines, based on the schedule, that a second job of the plurality of jobs is scheduled to execute during the execution of the first job. The controller estimates a first amount of memory to be consumed by executing the first job and a second amount of memory to be consumed by executing the second job and determines whether a sum of the first amount and the second amount exceeds an amount of free memory. The controller determines a table of the database that the first job accesses during execution and determines whether the table is accessed during execution of the second job. The controller communicates a message to the device indicating a period of time to wait before executing the first job if the sum of the first amount and the second amount exceeds the amount of free memory or if the table is accessed during execution of the second job.

Certain embodiments may provide one or more technical advantages. For example, an embodiment may reduce the amount of wasted processing resources caused by database jobs not completing due to insufficient resources. As another example, an embodiment may improve network efficiency by reducing the amount of traffic caused by database jobs that do not complete. Certain embodiments may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present disclosure, reference is now made to the following description, taken in conjunction with the accompanying drawings, in which:

FIG. 1 illustrates a system for managing a database;

FIG. 2 illustrates the database controller of the system of FIG. 1; and

FIG. 3 is a flowchart illustrating a method for managing a database using the system of FIG. 1.

### DETAILED DESCRIPTION

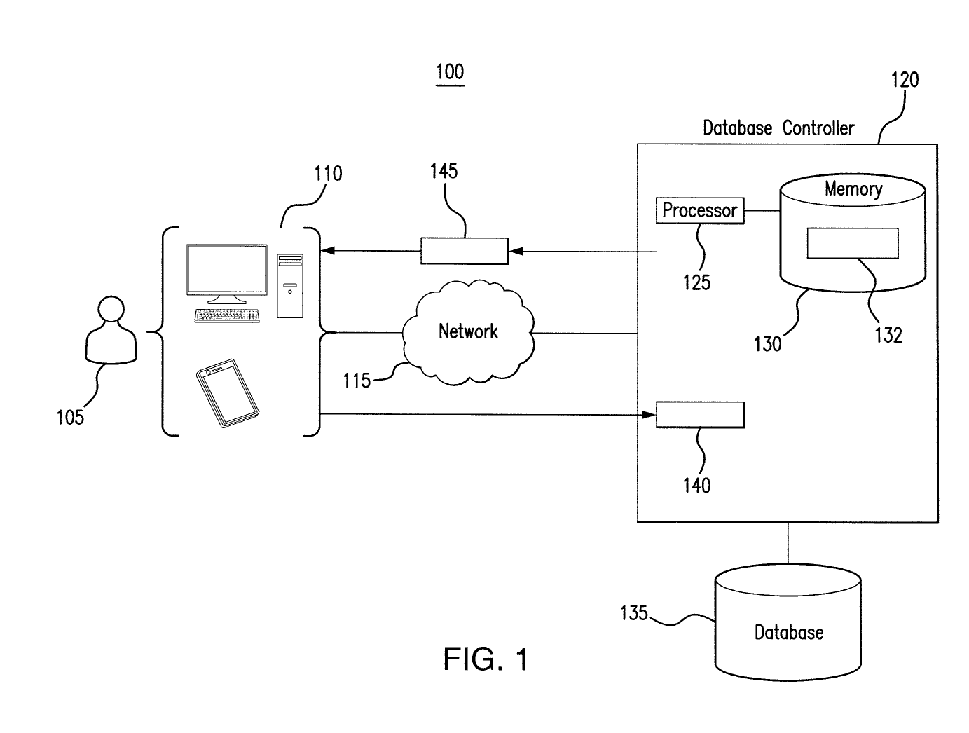

Embodiments of the present disclosure and its advantages are best understood by referring to FIGS. 1 through 3 of the drawings, like numerals being used for like and corresponding parts of the various drawings.

Databases may handle multiple jobs from multiple users concurrently. However, handling several jobs concurrently may result in inefficient execution due to insufficient system resources. In certain instances, some of these jobs may not complete or may be halted. When a job does not complete, a user may be presented with inaccurate results. In some cases, the inaccurate results may appear to have been generated by a job that completed, thereby misleading the user into relying upon the inaccurate results.

One way to reduce the number of incomplete jobs is for an administrator to ensure that there are sufficient resources to execute the job before kicking off or beginning execution of the job. However, the administrator may not always be available when the user wants to execute a job. If the administrator is not available, then the user may not be able to execute the job. Furthermore, even if the administrator was available, the administrator may not have a complete understanding of the available resources or the resource requirements. One example of a situation where the administrator may not have a complete understanding of the available resources or resource requirements is when a job is scheduled to begin automatically during the execution of a second job. In this instance, the administrator may not understand the resource requirements of the scheduled job before beginning execution of the second job. If the scheduled job and the second job consume more resources than are available, then one or both of the scheduled job and the second job may fail to complete.

A system is provided that may reduce the number of jobs that failed to complete. When a user requests to begin executing a job, the system may determine the resources that the job will consume during execution. The system may also determine the resources that any scheduled jobs will consume. The system may then determine whether there are sufficient available resources to begin execution of the requested job and any scheduled jobs that are scheduled to execute during execution of the requested job. If the system determines that there are insufficient resources available, the system may communicate a message to the user that instructs the user to wait a certain period of time before executing the job. In this manner, the system may reduce the amount of wasted resources caused by jobs that fail to complete execution. The system may also improve network efficiency by reducing the amount of traffic caused by jobs that do not complete. The system may also reduce a database administrator's manual efforts and the system may also improve the security associated with executing jobs against a database. The system will be described in further detail using FIGS. 1 through 3.

FIG. 1 illustrates a system 100 for managing a database 135. As provided in FIG. 1, system 100 includes a device 110, a network 115, a database controller 120, and a database 135. A user 105 may operate device 110. Device 110 may communicate with database controller 120 through network 115. Database controller 120 may communicate with and/or control database 135.

User 105 may use device 110 to communicate with database controller 120. For example, user 105 may use device 110 to request execution of a job against database 135. This disclosure contemplates device 110 being any appropriate device for sending and receiving communications over network 115. As an example and not by way of limitation, device 110 may be a computer, a laptop, a wireless or cellular telephone, an electronic notebook, a personal digital assistant, a tablet, or any other device capable of receiving, processing, storing, and/or communicating information with other components of system 100. Device 110 may also include a user interface, such as a display, a microphone, keypad, or other appropriate terminal equipment usable by user 105. In some embodiments, an application executed by device 110 may perform the functions described herein.

Network 115 may facilitate communication between and amongst each element of system 100. For example, network 115 may facilitate communication between device 110 and database controller 120. Network 115 may also facilitate communication between database controller 120 and database 135. This disclosure contemplates network 115 being any suitable network operable to facilitate communication between the components of system 100. Network 115 may include any interconnecting system capable of transmitting audio, video, signals, data, messages, or any combination of the preceding. Network 115 may include all or a portion of a public switched telephone network (PSTN), a public or private data network, a local area network (LAN), a metropolitan area network (MAN), a wide area network (WAN), a local, regional, or global communication or computer network, such as the Internet, a wireline or wireless network, an enterprise intranet, or any other suitable communication link, including combinations thereof, operable to facilitate communication between the components.

Database controller 120 may manage and/or control database 135. In particular embodiments, database controller 120 executes jobs against database 135. Database controller 120 includes a processor 125 and a memory 130 communicatively coupled to processor 125. Processor 125 and memory 130 may be configured to perform any of the functions of database controller 120 described herein. For example, memory 130 may be configured to store schedule 132. Processor 125 may be configured to determine whether there are sufficient resources to execute a requested job to completion.

Processor 125 may execute software stored on memory 130 to perform any of the functions described herein. Processor 125 may control the operation and administration of database controller 120 by processing information received from network 115 and memory 130. For example, processor 125 may receive request 140. Processor 125 may further determine if there are sufficient resources to execute a requested job to completion. Processor 125 may communicate a message 145 indicating that user 105 should wait before executing a requested job. Processor 125 may include any hardware and/or software that operates to control and process information. Processor 125 may be a programmable logic device, a microcontroller, a microprocessor, any suitable processing device, or any suitable combination of the preceding.

Memory 130 may store, either permanently or temporarily, data, operational software, or other information for processor 125. Memory 130 may include any one or a combination of volatile or non-volatile local or remote devices suitable for storing information. For example, memory 130 may include random access memory (RAM), read only memory (ROM), magnetic storage devices, optical storage devices, or any other suitable information storage device or a combination of these devices. The software represents any suitable set of instructions, logic, or code embodied in a computer-readable storage medium. For example, the software may be embodied in memory 130, a disk, a CD, or a flash drive. In particular embodiments, the software may include an application executable by processor 125 to perform one or more of the functions described herein.

This disclosure contemplates database controller 120 being distributed across multiple processors and multiple memories. Each processor and/or memory may be configured to perform any of the functions of database controller 120 described herein. For example, database controller 120 may include a web server and a database server. The database server may store statistics and information associated with executing jobs against database 135. The web server may communicate messages with device 110 and the database server. For example, the web server may communicate with a web interface executing on device 110. The web server may also determine whether there are sufficient resources to execute a requested job and whether there will be table conflicts. The web server may also determine a period of time to wait before requesting execution of a job and whether a user is authorized to execute the job. The web server may communicate commands to the database server to execute jobs and to poll for the status of executing jobs. For example, the web server can poll for the progress of executing jobs and report the results back to the web interface on device 110.

Database controller 120 may receive a request 140 from device 110. Request 140 may instruct database controller 120 to execute a particular job. In response to receiving request 140, database controller 120 may execute the job against database 135. In particular embodiments, database controller 120 may determine whether there are sufficient processing and memory resources available to complete execution of the requested job before starting execution of the requested job. In certain embodiments, database controller 120 may determine whether there will be table conflicts before starting execution of the requested job.

Database controller 120 may store a schedule 132 in memory 130. Schedule 132 may indicate times when certain jobs are scheduled to execute against database 135. Database controller 120 begins executing those jobs at the scheduled times. For example, if schedule 132 indicates a first job is scheduled to execute at 2:00 a.m., database controller 120 may begin executing the first job at 2:00 a.m. By using schedule 132, database controller 120 may execute jobs against database 135 without needing user 105 to request that the jobs be executed before each execution.

When a job is executing, resources of database controller 120 may be used. For example, executing a job may use a particular percentage of processing cycles of processor 125 and a portion of memory 130. When those resources are not available or become unavailable, an executing job may be unable to complete. For example, if user 105 requests execution of a first job, database controller 120 may begin executing the first job. If a second job is scheduled to begin execution while the first job is still executing, then database controller 120 may begin executing the second job while executing the first job. However, execution of the first and second jobs concurrently may require more processing and/or memory resources than are available in database controller 120. In such an instance, the first job may fail to complete.

In particular embodiments, database controller 120 may reduce the instances of failed jobs by determining whether sufficient resources will be available during execution of a requested job. If sufficient resources will not be available, database controller 120 may communicate a message 145 indicating that user 105 should wait a particular period of time before requesting execution of the requested job. For example, user 105 may request that a first job begin execution. Database controller 120 may receive request 140 indicating that the first job should begin execution. In response to receiving request 140, database controller may determine an amount of processor resources and memory resources required to execute the first job. Database controller 120 may also determine an amount of time needed to execute the first job. Database controller 120 may then analyze schedule 132 to determine whether a second job is scheduled to execute during execution of the first job. If the second job is scheduled to be executed during execution of the first job, database controller 120 may determine an amount of processor resources and memory resources required to execute the second job. Database controller 120 may then determine whether there are sufficient processor resources and memory resources available to execute the first job and the second job concurrently. If there are insufficient processor resources or memory resources available, database controller 120 may refuse to execute the first job and communicate message 145 to device 110. Message 145 may indicate a period of time to wait before executing the first job. User 105 may read message 145 and decide to wait that period of time. After that period of time has elapsed, user 105 may request execution of the first job again. In this manner, database controller 120 may increase the changes that the first job and the second job both complete execution.

In particular embodiments, database controller 120 also determines whether there are table conflicts caused by concurrently executing jobs. Using the previous example, database controller 120 may determine that both the first job and the second job access and/or write to a table in database 135. If the first job and the second job execute concurrently, then one of the jobs may fail to complete execution because it may not be granted access to the table. If database controller 120 determines that a table conflict will occur, database controller 120 may communicate message 145 to indicate the waiting time to user 105.

In certain embodiments, database controller 120 may provide user 105 with an option to schedule the first job to execute at the end of the waiting time if there are insufficient resources and/or if there will be a table conflict. Database controller 120 may include a prompt in message 145 that asks whether user 105 wants to schedule the first job to execute at the end of the waiting time. If user 105 wants to schedule the first job, the database controller 120 may add the first job to schedule 132 and indicate a start time at the end of the wait time. In this manner, user 105 may not need to manually request execution of the first job again at the end of the waiting time.

If database controller 120 determines that sufficient resources will be available to execute a requested job and/or that no table conflicts will arise, database controller 120 may begin execution of the requested job. In particular embodiments, database controller 120 may perform an additional check to determine whether user 105 has authorization to request execution of the job before executing the job. If user 105 does not have authorization to execute the job, database controller 120 may refuse execution of the job. In particular embodiments, database controller 120 may disable schedule 132. When schedule 132 is disabled, database controller 120 will not automatically begin executing the scheduled jobs at their scheduled times.

In particular embodiments, database controller 120 may log requested jobs and store the log in memory 130. The log may include a time that request 140 was received by database controller 120 and an identifier of the user 105 that communicated request 140. By maintaining the log, database controller 120 may track how often execution of a particular job is requested. In certain instances, if execution of a job is consistently requested at a particular time, database controller 120 may prompt a user 105 to create a schedule for the job. In this manner, the user 105 may avoid the need to manually request execution of the job.

In particular embodiments, database controller 120 may step through execution of a job. For example, a job may include a series of steps to be executed in a particular order. Database controller 120 may begin execution of the job from the first step or another step. If the job has five steps, database controller 120 may begin execution from the third step, for example. In this manner, if a job failed to complete previously, database controller 120 may begin execution from a step that previously failed to execute. In this manner, database controller 120 may not need to restart execution from the beginning of the job.

In operation, system 100 may perform various functions that reduce the number of jobs that failed to complete execution. To begin, user 105 may use device 110 to request that a first job begin execution. In response, device 110 may communicate a request 140 to database 120 through network 115. Database controller 120 may receive request 140 and determine that execution of the first job has been requested.

Database controller 120 may estimate and/or determine the resources that will be necessary to execute the first job. For example, database controller 120 may estimate a certain amount of processor and/or memory resources necessary to execute the first job. As another example, database controller 120 may determine tables of database 135 that the first job will access during execution. Database controller 120 may also estimate the amount of time it will take to complete execution of the requested job. In particular embodiments, database controller 120 may determine or estimate the resources and time needed to execute a requested job by analyzing the resources and time needed to execute the requested job previously. For example, database controller 120 may store the resources used during the previous execution of a job and the time it took to complete execution of the job. When execution of the job is requested again, database controller 120 may refer to the resources and time used during the previous execution to determine and/or estimate the resources and time needed for the requested execution.

Database controller 120 may then analyze schedule 132 to determine whether any jobs are scheduled to begin execution during execution of the first job. For example, database controller 120 may estimate that it will take one hour to complete the first job. Database controller 120 may then determine from schedule 132 that a second job is scheduled to begin execution in thirty minutes. From these determinations, database controller 120 may determine that the second job is scheduled to begin execution during the execution of the first job.

If database controller 120 determines that a scheduled job will begin execution during the execution of the first job, database controller 120 may then estimate and/or determine the resources needed to execute the scheduled job. Database controller 120 may also determine the tables of database 135 that the scheduled job will access during execution. Database controller may also estimate the amount of time it will take to complete execution of the scheduled job.

Database controller 120 may then determine whether there are sufficient resources available to execute the first job and the scheduled job concurrently. For example, database controller 120 may sum the estimated processor resources needed to execute the first job and the scheduled job. As another example, database controller 120 may sum the estimated memory resources needed to execute the first job and the scheduled job. Database controller 120 may then compare the sums with the available processor and memory resources in database controller 120. If any of these sums exceed the available resources, database controller 120 may communicate a message 145 to device 110. Message 145 may indicate that database controller 120 will not begin execution of the first job due to insufficient resources. Message 145 may also indicate a period of time to wait before user 105 should request execution of the first job again. Database controller 120 may determine the period of time using the estimated amount of time it will take to complete execution of the scheduled job. For example, if the scheduled job is estimated to take two hours, then the period of time may be any amount of time greater than or equal to two hours.

In particular embodiments, database controller 120 may also determine if a table conflict will arise between the first job and the scheduled job. For example, database controller 120 may determine that the first job and the scheduled job will both access the same table database 135. In this instance, database controller 120 may refuse to begin execution of the first job. Database controller 120 may also indicate a message 145 that the first job was not executed because of the table conflict.

In this manner, database controller 120 may reduce the number of jobs that failed to complete due to insufficient resources and/or table conflicts. In particular embodiments, by reducing the number of jobs that failed to complete, database controller 120 may reduce the amount of network traffic associated with jobs that failed to complete. In certain embodiments, by reducing the number of jobs that failed to complete, database controller 120 may reduce the amount of wasted processing and memory resources used to execute the job that failed to complete.

Modifications, additions, or omissions may be made to system 100 without departing from the scope of the invention. For example, database controller 120 may estimate or determine the resources needed to execute a scheduled job before receiving request 140. As another example, the components of system 100 may be integrated or separated. For example, database 135 may be incorporated into database controller 120.

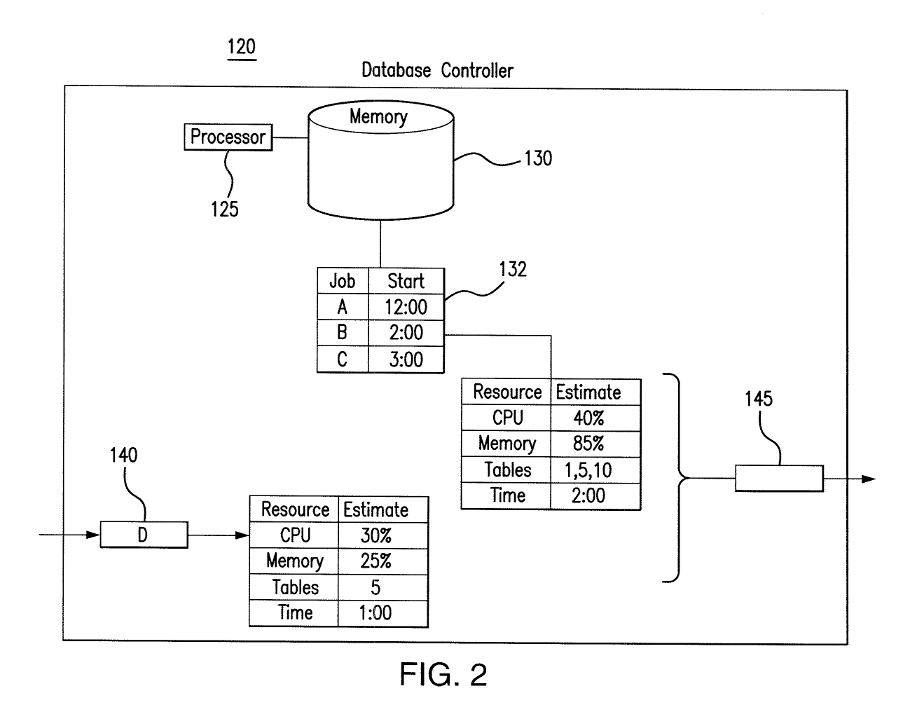

FIG. 2 illustrates the database controller 120 of the system 100 of FIG. 1. As provided in FIG. 2, database controller 120 may determine if there are sufficient resources and/or table conflicts for executing a requested job. As illustrated in FIG. 2, database controller 120 may determine if there are sufficient resources to execute a requested job. Database controller 120 may also determine if there are table conflicts that may arise from executing the requested job and a scheduled job. If there are insufficient resources to execute the requested job or if table conflicts will arise from executing the requested job, database controller 120 may communicate a message 145.

Database controller 120 may receive a request 140. Request 140 may indicate a job that is to be executed. As illustrated in FIG. 2, request 140 may request a job titled D be executed. In response to receiving request 140, database controller 120 may determine the resources needed to execute the requested job, the tables that the requested job will access during execution, and the time it will take to execute the job. Using the example of FIG. 2, database controller 120 may determine that job D needs 30% processing power and 25% of memory resources to execute. Database controller 120 may also determine that job D will access Table 5 during execution and that it will take about one hour to complete execution of job D.

In particular embodiments, database controller 120 may determine this information from previous executions of job D. For example, database controller 120 may determine that a previous execution of job D used 30% processing power and 25% of memory resources to execute. Based on that determination, database controller 120 may estimate that job D will need a 30% processing power and 25% of memory resources to execute this time. As another example, database controller 120 may determine that the previous execution of job D accessed table 5 and took about one hour to complete. Based on that determination, database controller 120 may anticipate that job D will access table 5 and estimate that job D will take about one hour to complete.

Database controller 120 may then determine whether another job is scheduled to execute during the execution of the requested job. Using the example of FIG. 2, database controller 120 may analyze schedule 132 to determine that a job titled A will start at noon, a job titled B will start at two and a job titled C will start at three. Then, assuming request 140 was received at 1:30, based on the prior determination that job D is estimated to take one hour to complete, database controller 120 may determine that job B will begin execution during execution of job D.

In response to the determination that job B will begin execution during the execution of job D, database controller 120 may estimate the resources needed to execute job B and the tables that job B will access during execution. In the example of FIG. 2, database controller 120 may determine that job B needs 40% processing resources and 85% of memory resources to execute. Database controller 120 may also estimate that job B will access tables one, five, and ten. Database controller 120 may further estimate an amount of time it will take for job B to complete execution. In the previous example, database controller 120 may estimate that job B will take about two hours to execute.

Database controller 120 may then evaluate whether there is sufficient resources to execute the requested job and the scheduled job. In the example of FIG. 2, database controller 120 may determine that there are sufficient processing resources to execute job D and job B concurrently because job D needs only 30% of the processing resources and job B needs only 40% of the processing resources to complete. Assuming 100% of the processing resources are available to both job D and job B, database controller 120 may determine that job D and job B may execute concurrently because the total processing needed to execute job D and job B is 70%. However, database controller 120 may determine that there are insufficient memory resources to execute job D and job B concurrently, because job D needs 25% of memory resources to complete while job B needs 85% of memory resources to complete. Because the sum of memory resources needed to complete both jobs is 110%, database controller may determine that there are insufficient memory resources to concurrently complete job D and job B.

Database controller 120 may further determine if there are any table conflicts arising from concurrent executions of the requested job and the scheduled job. Using the example of FIG. 2, database controller 120 may determine that there is a table conflict because both job D and job B access Table 5 during execution. As a result of the table conflict, one or both of job D and job B may not complete execution.

Database controller 120 may communicate message 145 if database controller 120 determines that there are insufficient resources to execute the requested job and/or if there is a table conflict arising from executing the requested job. Message 145 may indicate that there are insufficient resources or that there is a table conflict. Message 145 may also indicate a period of time to wait before execution of the requested job should be requested again. Using the example of FIG. 2, message 145 may indicate that there are insufficient memory resources to execute job D. Message 145 may further indicate that there are table conflicts that could cause job D to not execute completely. Because database controller 120 estimated that job B will need two hours to complete, message 145 may indicate that a user should wait at least two hours before requesting that job D be executed again.

In particular embodiments, by communicating message 145, database controller 120 may reduce the number of jobs that fail to complete. In so doing, database controller 120 may conserve processing and memory resources that would have otherwise been used to execute the job.

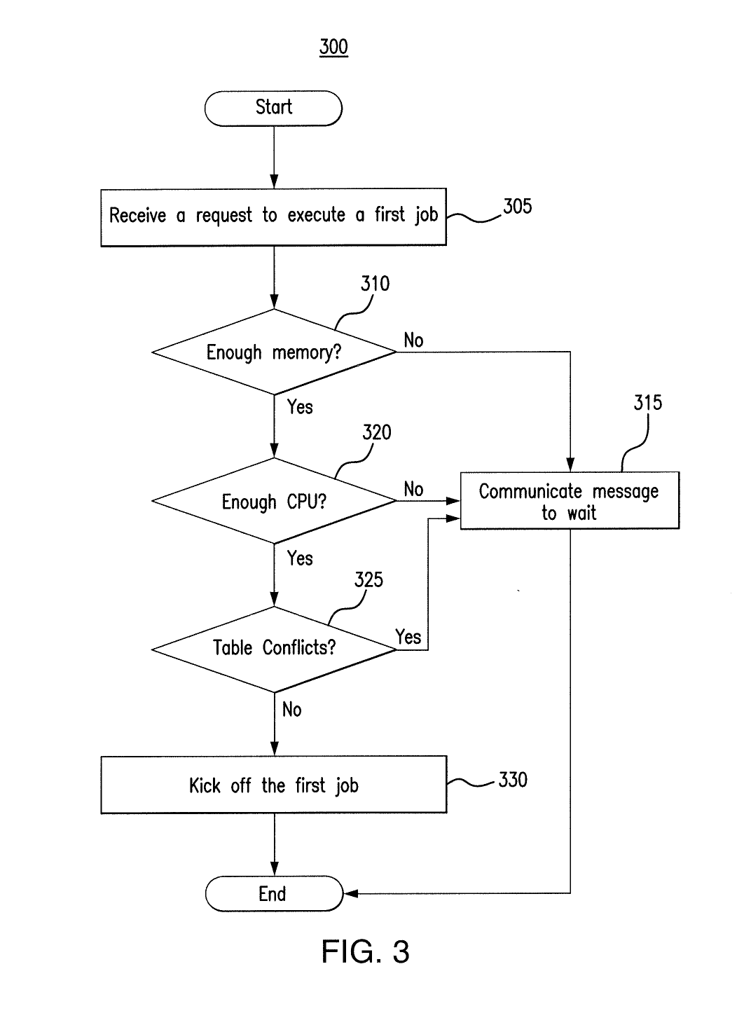

FIG. 3 is a flowchart illustrating a method 300 for managing a database 135 using the system 100 of FIG. 1. In particular embodiments, database controller 120 may perform method 300. Database controller 120 may begin by receiving a request to execute a first job in step 305. In response to receiving the request, database controller 120 may determine whether there is another job scheduled to begin execution during the execution of the first job. In certain embodiments, database controller 120 may determine whether another job is scheduled to begin execution during execution of the requested job based on an estimate of the amount of time it will take to complete execution of the requested job.

In step 310, database controller 120 may determine if there is enough memory to complete execution of the first job. If there is another job scheduled to begin execution during the first job, database controller 120 may determine whether there is sufficient memory to execute both jobs concurrently. If there is not enough memory, database controller 120 may proceed to step 315 to communicate a message to wait before requesting execution of the first job again. Upon seeing the message, a user may wait for a period of time before beginning execution of the first job. In particular embodiments, the period of time may be determined based on an estimated amount of time it will take to complete execution of the scheduled job.

If there is enough memory, database controller 120 may proceed to step 320 to determine if there are sufficient processing resources. If there is another job scheduled to begin execution during the execution of the first job, database controller 120 may determine if there are sufficient processing resources to execute both jobs concurrently. If there are not sufficient processing resources, database controller 120 may proceed to step 315 to communicate the message to wait.

If there are sufficient processing resources, database controller 120 may proceed to step 325 to determine if there are table conflicts. If there is another job scheduled to begin execution during execution of the first job, database controller 120 may determine whether the scheduled job and the first job access one or more of the same tables in the database during execution. If database controller 120 determines that there will be table conflicts, database controller 120 may proceed to step 315 to communicate the message to wait. If database controller 120 determines that there are no table conflicts, database controller 120 may proceed to step 330 and kick off the first job.

In particular embodiments, by performing method 300 database controller 120 may reduce the number of jobs that failed to execute completely. As a result, database controller 120 may reduce the amount of processing and/or memory resources wasted on executing jobs that do not complete. Database controller 120 may also reduce network traffic associated with executing jobs that do not complete.

Modifications, additions, or omissions may be made to method 300 depicted in FIG. 3. Method 300 may include more, fewer, or other steps. For example, steps may be performed in parallel or in any suitable order. While discussed as database controller 120 performing the steps, any suitable component of system 100, such as device 110 for example, may perform one or more steps of the method.

Although the present disclosure includes several embodiments, a myriad of changes, variations, alterations, transformations, and modifications may be suggested to one skilled in the art, and it is intended that the present disclosure encompass such changes, variations, alterations, transformations, and modifications as fall within the scope of the appended claims.

What is claimed is:

1. An apparatus comprising:
a memory operable to store a schedule indicating, for each job of a plurality of jobs, a time when the job is scheduled to execute against a database; and
a processor communicatively coupled to the memory and operable to:
receive a request to execute a first job against the database;
determine, based on the schedule, that a second job of the plurality of jobs is scheduled to execute during the execution of the first job;
estimate a first amount of memory to be consumed by executing the first job and a second amount of memory to be consumed by executing the second job;
determine whether a sum of the first amount and the second amount exceeds an amount of free memory;
determine a table of the database that the first job accesses during execution;
determine whether the table is accessed during execution of the second job;
communicate a message indicating a period of time to wait before executing the first job if the sum of the first amount and the second amount exceeds the amount of free memory or if the table is accessed during execution of the second job.

2. The apparatus of claim 1, wherein the processor is further operable to:
estimate a first amount of processing power used to execute the first job and a second amount of processing power used to execute the second job;
determine whether a sum of the first amount of processing power and the second amount of processing power exceeds an amount of free processing power; and
communicate the message indicating the period of time to wait if the sum of the first amount of processing power and the second amount of processing power exceeds the amount of free processing power.

3. The apparatus of claim 1, wherein processor is further operable to begin execution of the first job if the sum of the first amount and the second amount does not exceed the amount of free memory and if the table is not accessed during execution of the second job.

4. The apparatus of claim 1, wherein the processor is further operable to determine that a user that communicated the request has authorization to execute the job before beginning execution of job.

5. The apparatus of claim 1, wherein the processor is further operable to store in a log:
a time that the request was received; and
a user that communicated the request.

6. The apparatus of claim 1, wherein the processor is further operable to disable the schedule so that the second job does not execute at the time it is scheduled to execute against the database.

7. The apparatus of claim 1, wherein:
the first job comprises a plurality of steps to be executed in a particular order; and
the processor is further operable to begin execution of the first job from a step of the plurality of steps other than the first step of the particular order.

8. A method comprising:
storing, by a memory, a schedule indicating, for each job of a plurality of jobs, a time when the job is scheduled to execute against a database;
receiving, by a processor communicatively coupled to the memory, a request to execute a first job against the database;
determining, by the processor, based on the schedule, that a second job of the plurality of jobs is scheduled to execute during the execution of the first job;
estimating, by the processor, a first amount of memory to be consumed by executing the first job and a second amount of memory to be consumed by executing the second job;
determining, by the processor, whether a sum of the first amount and the second amount exceeds an amount of free memory;
determining, by the processor, a table of the database that the first job accesses during execution;
determining, by the processor, whether the table is accessed during execution of the second job;
communicating, by the processor, a message indicating a period of time to wait before executing the first job if the sum of the first amount and the second amount exceeds the amount of free memory or if the table is accessed during execution of the second job.

9. The method of claim 8, further comprising:
estimating, by the processor, a first amount of processing power used to execute the first job and a second amount of processing power used to execute the second job;
determining, by the processor, whether a sum of the first amount of processing power and the second amount of processing power exceeds an amount of free processing power; and
communicating, by the processor, the message indicating the period of time to wait if the sum of the first amount of processing power and the second amount of processing power exceeds the amount of free processing power.

10. The method of claim 8, further comprising beginning execution of the first job if the sum of the first amount and the second amount does not exceed the amount of free memory and if the table is not accessed during execution of the second job.

11. The method of claim 8, further comprising determining, by the processor, that a user that communicated the request has authorization to execute the job before beginning execution of job.

12. The method of claim 8, further comprising storing, by the processor, in a log:
a time that the request was received; and
a user that communicated the request.

13. The method of claim 8, further comprising disabling, by the processor, the schedule so that the second job does not execute at the time it is scheduled to execute against the database.

14. The method of claim 8, further comprising beginning execution of the first job, the first job comprising a plurality of steps to be executed in a particular order, wherein execution begins from a step of the plurality of steps other than the first step of the particular order.

15. A system comprising:
a device operable to communicate a request to execute a first job against the database;
a controller communicatively coupled to the client, the controller operable to:
store a schedule indicating, for each job of a plurality of jobs, a time when the job is scheduled to execute against a database;
receive the request to execute the first job against the database;
determine, based on the schedule, that a second job of the plurality of jobs is scheduled to execute during the execution of the first job;
estimate a first amount of memory to be consumed by executing the first job and a second amount of memory to be consumed by executing the second job;
determine whether a sum of the first amount and the second amount exceeds an amount of free memory;
determine a table of the database that the first job accesses during execution;
determine whether the table is accessed during execution of the second job;
communicate a message to the device indicating a period of time to wait before executing the first job if the sum of the first amount and the second amount exceeds the amount of free memory or if the table is accessed during execution of the second job.

16. The system of claim 15, wherein the controller is further operable to:
estimate a first amount of processing power used to execute the first job and a second amount of processing power used to execute the second job;
determine whether a sum of the first amount of processing power and the second amount of processing power exceeds an amount of free processing power; and
communicate the message indicating the period of time to wait if the sum of the first amount of processing power and the second amount of processing power exceeds the amount of free processing power.

17. The system of claim 15, wherein controller is further operable to begin execution of the first job if the sum of the first amount and the second amount does not exceed the amount of free memory and if the table is not accessed during execution of the second job.

18. The system of claim 15, wherein the controller is further operable to determine that a user that communicated the request has authorization to execute the job before beginning execution of job.

19. The system of claim 15, wherein the controller is further operable to store in a log:
a time that the request was received; and
a user that communicated the request.

20. The system of claim 15, wherein the controller is further operable to disable the schedule so that the second job does not execute at the time it is scheduled to execute against the database.

21. The system of claim 15, wherein:
the first job comprises a plurality of steps to be executed in a particular order; and
the controller is further operable to begin execution of the first job from a step of the plurality of steps other than the first step of the particular order.
